(19) United States
(12) Patent Application Publication
(10) Pub. No.: US 2026/0058959 A1
(43) Pub. Date: Feb. 26, 2026

(54) Method, Communication Device, and Computer Program Product for Secure Communication

(71) Applicants: Robert Bosch GmbH, Stuttgart (DE); Bosch Automotive Products (Suzhou) Co. Ltd., Suzhou (CN)

(72) Inventors: Longan Jin, Suzhou (CN); Zheng Li, Suzhou (CN)

(21) Appl. No.: 19/308,194

(22) Filed: Aug. 23, 2025

(30) Foreign Application Priority Data
Aug. 26, 2024 (CN) 2024 1117 3363.5

(51) Int. Cl. H04L 9/40

(52) U.S. Cl. CPC H04L 63/123

(57) ABSTRACT

A method for secure communication includes (S1) generating a sender composite authentication code based on multiple messages to be transmitted, the sender composite authentication code being used for the overall security verification of a plurality of messages to be transmitted as a whole, (S2) transmitting the plurality of messages to be transmitted to the receiver as first transmission messages, wherein the first transmission messages do not contain any form of authentication code, and (S3) transmitting the sender composite authentication code to the receiver as a second transmission message, wherein the second transmission message is transmitted separately from the first transmission message. A communication device and a computer program product associated with this method is also disclosed.

This application claims priority under 35 U.S.C. § 119 to application no. CN 2024 1117 3363.5, filed on Aug. 26, 2024 in China, the disclosure of which is incorporated herein by reference in its entirety.

The present application relates to a method for secure communication. The present application also relates to a communication device and a computer program product.

### BACKGROUND

With the increasing number of Electronic Control Units (ECUs) in vehicles, the demand for reliable in-vehicle communication has also grown. Against this backdrop, SecOC (Secure Onboard Communication) mechanism has emerged. As an information security component within the AUTOSAR architecture, the SecOC mechanism is capable of generating and verifying Message Authentication Codes (MAC) for data transmitted over the bus, thereby effectively preventing risks of data tampering and spoofing.

Currently, it is common practice to reserve a fixed space in each CAN (Controller Area Network) frame to store the MAC. However, this conventional transmission protocol presents several significant issues. First, since each CAN frame needs to reserve space for the MAC, the frame utilization is limited, resulting in a waste of bandwidth resources. Second, existing Hardware Security Modules (HSMs) have relatively low processing efficiency, making it difficult to meet the demands of high-frequency communication. In particular, when frequent data exchanges among various ECUs in the in-vehicle network are required, the inefficiency of hardware security modules becomes a bottleneck in system performance.

In this context, there is a need for an improved in-vehicle communication scheme.

### SUMMARY

The objective of the present application is to provide a method for secure communication, a communication device, and a computer program product, so as to at least address some of the issues in the prior art.

According to a first aspect of the present application, a method for secure communication is provided. The method comprises the following steps:
step S1: generating a sender composite authentication code based on multiple messages to be transmitted, the sender composite authentication code being used for the security verification of the group of messages as a whole;
step S2: transmitting the multiple messages to be transmitted to a receiver as a first transmission message, wherein the first transmission message does not contain any form of authentication code;
step S3: transmitting the sender composite authentication code to the receiver as a second transmission message, wherein the second transmission message is transmitted separately from the first transmission message.

The present application includes the following technical concept: By transmitting the message content and the composite authentication code separately, it eliminates the need to reserve individual storage space for the authentication code in each message, thereby improving frame utilization. In addition, by generating a composite authentication code for multiple messages in batches or performing batch verification, the frequency of HSM invocation is reduced, which effectively lowers the demand for inter-core communication and enhances overall computational efficiency. This design provides a more efficient and reliable solution for secure communications between the ECUs.

In an exemplary embodiment, the method further comprises the following steps:
step S4: receiving an additional first transmission message, which includes multiple additional messages to be transmitted and does not contain any form of authentication code;
step S5: receiving an additional second transmission message, which includes an additional sender composite authentication code, the additional sender composite authentication code being used for the security verification of the group of additional messages to be transmitted as a whole, wherein the additional second transmission message is transmitted separately from the additional first transmission message;
step S6: generating a receiver composite authentication code from the multiple additional messages to be transmitted; and
step S7: performing security verification on the multiple additional messages to be transmitted based on the receiver composite authentication code and the additional sender composite authentication code.

According to a second aspect of the present application, a communication device is provided. The communication device comprises a memory and a processor, wherein the memory stores computer program instructions which, when executed by the processor, enable the processor to perform the method according to the first aspect of the present disclosure.

According to a third aspect of the present application, a communication device is provided. The communication device comprises:

A main processor, configured to:
generate a composite message based on multiple messages to be transmitted;
transmit the composite message to a hardware security module;
receive a sender composite authentication code from the hardware security module;
transmit the multiple messages to be transmitted to a receiver as a first transmission message, wherein the first transmission message does not contain any form of authentication code;
transmit the sender composite authentication code to the receiver as a second transmission message, wherein the second transmission message is transmitted separately from the first transmission message.

A hardware security module, configured to:
generate the sender composite authentication code based on the composite message;
transmit the sender composite authentication code to the main processor.

In an exemplary embodiment, the main processor of the communication device is further configured to:
receive an additional first transmission message, which includes multiple additional messages to be transmitted and does not contain any form of authentication code;
receive an additional second transmission message, which includes an additional sender composite authentication code, the additional sender composite authentication code being used for the security verification of the group of additional messages to be transmitted as a whole, wherein the additional second transmission message is transmitted separately from the additional first transmission message;
generate an additional composite message based on the received multiple additional messages to be transmitted;
transmit the additional composite message and the received additional sender composite authentication code to the hardware security module;

The hardware security module is further configured to:
generate a receiver composite authentication code based on the additional composite message;
perform security verification on the multiple additional messages to be transmitted based on the receiver composite authentication code and the additional sender composite authentication code.

According to a fourth aspect of the present application, a computer program product is provided. The computer program product comprises a computer program which, when executed by a processor, implements the method according to the first aspect of the present application.

### BRIEF DESCRIPTION OF THE DRAWINGS

In the following, the present application is described in greater detail with reference to the accompanying drawings to provide a better understanding of its principles, features, and advantages. The accompanying drawings include the following:

FIG. 1 illustrates a flowchart of a method for secure communication according to an exemplary embodiment of the present application;

FIG. 2 illustrates a flow of a method for secure communication according to another exemplary embodiment of the present application.

FIG. 3 illustrates a flowchart of a method for secure communication according to another exemplary embodiment of the present application;

FIG. 4 illustrates a flowchart of a method for secure communication according to another exemplary embodiment of the present application;

FIG. 5 illustrates a flowchart of a method for secure communication according to another exemplary embodiment of the present application;

FIG. 6 illustrates a data structure diagram of the first transmission message, second transmission message, and composite message according to an exemplary embodiment of the present application.

FIG. 7 illustrates a schematic diagram of a communication device according to an exemplary embodiment of the present application;

FIG. 8 illustrates a schematic diagram of a communication device according to another exemplary embodiment of the present application;

FIG. 9 illustrates a schematic diagram of a communication system according to an exemplary embodiment of the present application.

### DETAILED DESCRIPTION

To provide a clearer understanding of the technical problems, technical solutions, and beneficial technical effects to be addressed by the present application, the following detailed description of the present application will be provided with reference to the accompanying drawings and multiple exemplary examples. It should be understood that the specific examples described herein are provided solely for the purpose of explaining the present application and not for limiting the scope of protection of the present application.

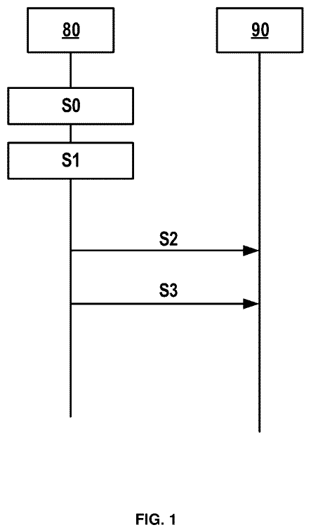

FIG. 1 illustrates a flowchart of a method for secure communication according to an exemplary embodiment of the present application. In FIG. 1, the primary function of the communication device 80 as a sender is described. To facilitate a more comprehensive description of the communication process, the communication device 90 of the receiver is also shown in FIG. 1; however, the receiver's communication device 90 is not required to actively participate in the execution of the method.

In step S0, multiple messages to be transmitted are obtained. For example, the communication device 80 of the sender may receive sensitive data units (Authentic I-PDUs) from the upper layer (i.e., the application software layer under the AUTOSAR layered architecture) and append additional information to form the messages to be transmitted. The sensitive data units, also referred to as data units requiring protection, which may originate from, for example, vehicle sensor data, control commands, or other information units that require secure transmission. The data structure of the messages to be transmitted may include, for example, the following parts: message ID, sensitive data unit, and freshness value (FV). The message ID may be, for example, a CAN-ID or another identifier defined in other ways, which is used to uniquely identify each message to be transmitted. The freshness value may be, for example, a monotonically increasing sequence or timestamp generated by a local counter in the communication device 80, which is used to prevent replay attacks.

In step S1, a sender composite authentication code is generated based on multiple messages to be transmitted. The sender composite authentication code is used for the security verification of the group of messages as a whole.

For example, the communication device 80 of the sender serializes the collected multiple messages to be transmitted, such as arranging and concatenating them in a predetermined order to form a composite message. This order may be determined based on factors such as message type, priority, transmission sequence, or the time sequence in which the sensitive data units are received from the upper layer. In addition to simple sorting and concatenation, the generation of the composite message may involve other operations or calculations. For instance, specific mathematical operations, logical combinations, or data transformations may be performed on the multiple messages to be transmitted to ensure that the composite message meets certain security or communication standards. The composite message integrates all the messages to be transmitted and serves as the essential data basis for security verification. Using the composite message, a composite authentication code is generated through encryption algorithms and keys. This process is similar to the generation process of a single Message Authentication Code (MAC), but for a composite message rather than a single message. The sender composite authentication code is unique and closely associated with the entire set of messages to be transmitted, and it serves as the authentication basis for determining the security and trustworthiness of the multiple messages.

Optionally, in step S1, an ID list may also be generated based on the multiple messages to be transmitted, which ID list includes a message ID corresponding to each message to be transmitted. The order in the ID list may be fixed or dynamically varied. This order determines the sequence in which the messages are combined during the generation of the composite authentication code. The number of IDs included can be preset or flexibly adjusted according to actual conditions, to accommodate different communication requirements and network conditions. In addition, if an ID list is generated, the generation of the sender composite authentication code will strictly follow the order recorded in the ID list. Such a design ensures that the receiver can generate a receiver composite authentication code according to the same rules, thereby enabling accurate verification of each message by the receiver.

In step S2, the multiple messages to be transmitted are sent to the receiver 90 as a first transmission message, wherein the first transmission message does not contain any form of authentication code. This indicates that the first transmission message includes neither individual authentication codes for the single messages to be transmitted nor a composite authentication code for the multiple messages.

In one embodiment, the communication device 80 of the sender transmits each message to be transmitted independently as a first transmission message. This means that each message to be transmitted is an individual transmission unit, sent sequentially from the sender 80 to the receiver 90. The transmission order of all first transmission messages may be predetermined or random. In another embodiment, the communication device 80 of the sender packages a series of messages to be transmitted into a single first transmission message and transmits it. In another embodiment, the communication device 80 of the sender generates a composite message from multiple messages to be transmitted and forms a single first transmission message for transmission.

The first transmission message contains only the actual data content that needs to be transmitted, without including any message authentication codes for this data. This design allows messages to be transmitted more rapidly without carrying authentication information, thereby improving communication efficiency. Furthermore, there is no need to reserve storage space for the message authentication code in each transmission message, which enhances frame utilization and enables the system to use bandwidth more effectively.

In step S3, the sender composite authentication code is transmitted to the receiver 90 as a second transmission message, which is sent separately from the first transmission message. The second transmission message includes neither any individual message to be transmitted nor the composite message generated from multiple messages to be transmitted.

In the context of the present application, “transmitted separately” is understood to mean that the second transmission message is transmitted independently of the first transmission message. This means that they are physically separate, even if they may be temporally close or consecutive. Sending the messages separately can also reduce the risk of tampering with the authentication code.

In one embodiment, the transmission timing of the second transmission message may be correlated with that of the first transmission message. For example, the second transmission message may be designed to be sent within a predetermined time interval after the first transmission message. This agreed-upon time interval or transmission sequence ensures that, even without a directory or index regarding the messages to be transmitted included in the second transmission message, the first and second transmission messages can still be correctly associated and processed by the receiver.

In one embodiment, the transmission timing of the second transmission message is not directly related to that of the first transmission message. This means that the second transmission message can be transmitted at any time, without being constrained by the transmission timing of the first transmission message. This allows the sender's communication device 80 to determine when to send the second transmission message based on network conditions or other factors. Typically, it is permitted for the second transmission message to be sent with a delay relative to the first transmission message. This enables the receiver 90 to process the message to be transmitted without waiting for the composite authentication code, thereby reducing the wait time and improving overall communication efficiency.

In one embodiment, the second transmission message optionally includes an ID list. This ID list contains the message IDs of each message to be transmitted sent in step S2. This indicates that the sender's composite authentication code and ID list may be combined into the second transmission message. Similarly, the second transmission message may optionally include a freshness value to ensure its timeliness and prevent replay attacks. In practical applications, the communication device 80 may, for example, flexibly adjust the content of the second transmission message according to network conditions and security requirements to determine whether to include the ID list and the freshness value.

In one embodiment, either the traditional transmission protocol or the newly defined transmission protocol may be selected for communication based on the current data load of the in-vehicle network. For example, when the data load of the in-vehicle network is low, or when the messages to be transmitted have high requirements for timeliness and security, the communication device 80 may adopt the traditional transmission protocol. Specifically, an individual message authentication code (MAC) is generated for each message to be sent and combined with the message itself to form a third transmission message, which is then sent to the receiver. When the in-vehicle network data load rate is high, in order to improve transmission efficiency, the newly defined transmission protocol may instead be used, i.e., the messages to be transmitted and the composite authentication code are sent separately. In this way, the most suitable transmission protocol can be selected under different scenarios, ensuring security while optimizing communication efficiency and bandwidth utilization.

It should be noted that although step S2 in FIG. 1 is shown as being performed after step S1, this sequence is merely exemplary. In the actual situation, step S2 may be performed before step S1, or steps S1 and S2 may be carried out alternately or in parallel as needed.

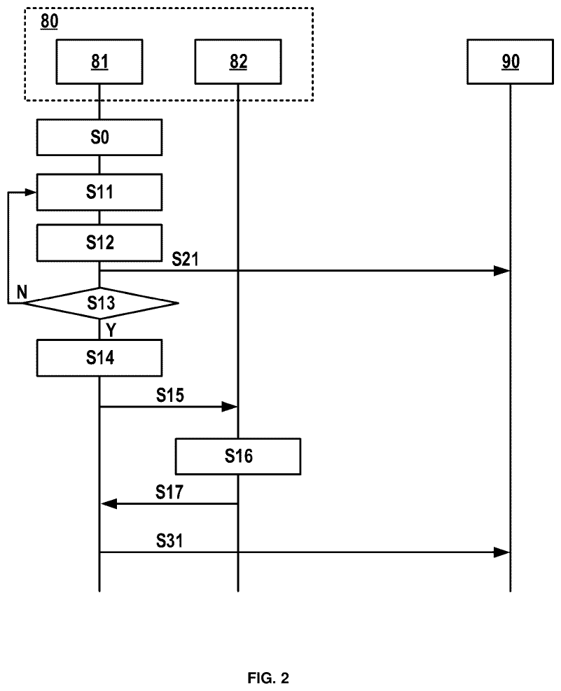

FIG. 2 illustrates a flow of a method for secure communication according to another exemplary embodiment of the present application. In this embodiment, the communication device 80 is further shown to include a main processor 81 and a hardware security module 82, thereby providing a more detailed illustration of the interaction between the two.

In step S0, multiple messages to be transmitted are acquired by the main processor 81 of the communication device 80. The specific operational details of this step have been described in FIG. 1 and will not be repeated here.

In step S11, each message to be transmitted is copied to a buffer by the main processor 81 of the communication device 80. In optional step S12, the ID of each message to be transmitted may also be stored in the buffer. By way of example, for each message that is ready for transmission, the main processor 81 may be responsible for sequentially storing the message ID, sensitive data unit, and freshness value into a buffer queue.

In step S21, immediately after the message to be transmitted is copied to the buffer, the copied message is sent as a first transmission message. Here, “immediately sent” means that the transmission is performed directly after the copying is completed, without waiting for the buffer list to be filled or the expiration of a timer. As such, the real time of system communication is improved to reduce the delay in utilizing relevant data on the receiving end caused by waiting for the generation of a composite authentication code.

In step S13, the main processor 81 of the communication device 80 checks whether the conditions for generating the sender's composite authentication code are met.

In one embodiment, at step S13, the main processor 81 may check whether the number of buffered messages to be transmitted has reached a preset threshold. If the preset threshold has been reached, further collection of messages to be transmitted may be stopped at step S14, and a composite message may be generated using all the buffered messages. If it is determined at step S13 that the number of messages in the buffer queue has not yet reached the preset threshold, the process returns to step S11 to continue collecting messages to be transmitted until the required number is reached. This number may be preset or adjusted based on actual usage.

In another embodiment, at step S13, the main processor 81 may also check whether the sender timer has expired. If the sender timer has not expired, the process returns to the previous step S11 to continue copying messages to be transmitted into the buffer. If the sender timer has expired, the collection of messages to be transmitted is stopped at step S14, and a composite message is generated using all the buffered messages.

This operation provides flexibility, allowing the system to determine when to generate the composite authentication code based on either the number of messages or a timing condition, thereby optimizing communication efficiency and response time.

Optionally, the sender timer used may be, for example, a periodic timer. This periodic timer has a timing start point and a predefined timing interval that are independent of external events. This means that the start and end of each timing cycle are based on its own internal cycle. A periodic timer does not require synchronization with external events, thereby reducing system synchronization complexity and the need for high synchronization accuracy. Furthermore, the use of a periodic timer simplifies system design, as no additional control logic is needed to handle event-based trigger conditions.

Optionally, the sender timer used may also be triggered in response to the collection of a message to be transmitted, which is intended for generating the sender composite authentication code, and may have a timing duration related to the characteristics of the message itself. For example, whenever a message to be transmitted is copied into the buffer queue, the corresponding sender timer is started. The timing duration of each sender timer can be determined based on the urgency level of the corresponding message to be transmitted. This means that different messages to be transmitted may correspond to different timing durations, thereby allowing the system to dynamically schedule the generation of the composite authentication code based on the actual characteristics of each message. Among all the sender timers, the expiration of the earliest one will trigger the generation of the sender composite authentication code. This ensures that generation of the sender's composite authentication code is associated with the most urgent message to be transmitted. Through this design, the communication device 80 is able to flexibly handle messages of varying urgency while ensuring security, thereby achieving efficient and reliable data transmission.

By way of example, for a first message to be transmitted with a lower urgency level, the main processor 81 starts a sender timer set to 15 milliseconds (ms). For a second message to be transmitted with a higher urgency level, the main processor 81 starts a sender timer set to 10 milliseconds (ms). Although the second message has a shorter timer duration, if the time interval between the second message entering the buffer queue and the expiration of the first message's timer is only 5 milliseconds, the timer for the second message will not determine the trigger time for generating the composite authentication code. This indicates that even with shorter timers present, the system will still wait for the earliest expiration among all active timers to ensure that the authentication code covers all buffered messages to be transmitted.

Optionally, the timing duration of the sender timer may also be dynamically adjusted based on actual network conditions and communication requirements.

In step S15, the main processor 81 of the communication device 80 transmits the composite message generated in step S14 to the hardware security module 82 of the communication device 80.

In step S16, the hardware security module 82 calculates the sender composite authentication code based on the received composite message. This step ensures that the hardware security module 82 is able to generate the authentication code in batches for the set of multiple messages to be transmitted, thereby improving the processing efficiency of the hardware security module 82. In addition, this operation reduces multiple calls to the hardware security module 82. Since the hardware security module 82 typically has an independent processing core, it also reduces cross-core communication requirements with the main processor 81.

In step S17, the hardware security module 82 of the communication device 80 returns the generated sender composite authentication code to the main processor 81. Finally, in step S31, the main processor 81 combines the sender composite authentication code with the (optional) ID list to form the second transmission message, which is then sent to the receiver 90.

It should be noted that although in the embodiment shown in FIG. 2, the composite message of multiple messages to be transmitted is first generated by the main processor, and then the hardware security module generates the sender composite authentication code based on the composite message. However, it is also possible that the main processor transmits multiple messages to be transmitted to the hardware security module either all at once or one by one. The hardware security module then performs the merging operation on the multiple messages and generates the composite authentication code accordingly.

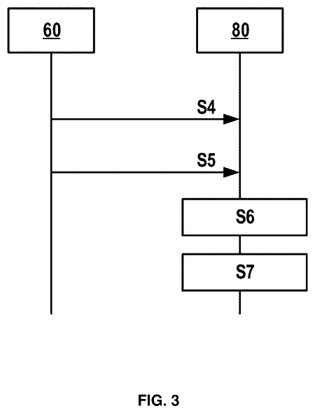

FIG. 3 illustrates a flowchart of a method for secure communication according to another exemplary embodiment of the present application. In FIG. 3, the method shown in FIG. 1 further includes additional steps S4 to S7, which may likewise be carried out with the aid of the communication device 80. In FIG. 3, the functions of the communication device 80 as a receiver are primarily described.

It should be noted that steps S4 to S7 are numbered sequentially with steps S1 to S3 for ease of explanation; however, they are in fact independent of steps S1 to S3. In practical operation, steps S4 to S7 may be performed concurrently with, alternately with, or before or after steps S1 to S3.

It should be noted that the method for secure communication shown in FIG. 3 is, for example, executed by the communication device 80.

To facilitate a more comprehensive description of the communication process, the communication device 60 acting as the sender is also illustrated in FIG. 3. However, the sender's communication device 60 is not mandatorily required to actively participate in the execution of this method.

In step S4, the receiver's communication device 80 receives an additional first transmission message, which includes multiple additional messages to be transmitted and does not contain any form of authentication code.

In one embodiment, the receiver's communication device 80 may independently receive multiple additional first transmission messages, each of which includes one of the additional messages to be transmitted. The order in which the additional first transmission messages arrive at the receiver's communication device 80 may be predetermined or unordered. This means that the arrival sequence of the additional first transmission messages may be the same as or different from the transmission order at the sender 60 (due to factors such as network delay, transmission strategies, or other influences). In some cases, the receiver's communications device 80 needs to reorder each additional message according to its content (e.g., timestamps, sequence numbers, additional message IDs, or other identifiers) to ensure that they can be processed in the correct order in subsequent steps. In some cases, if the generation of the authentication code by the additional sender does not depend on the order of the messages, or if the processing logic has already been predefined by the system, the receiver's communication device 80 does not need to reassemble the received additional messages to be transmitted.

In another embodiment, the receiver's communication device 80 may also receive a single additional first transmission message, which includes an additional composite message generated from multiple additional messages to be transmitted.

In step S5, the receiver's communication device 80 receives another second transmission message, which includes an additional sender composite authentication code. This additional sender composite authentication code is used for the overall security verification of the multiple additional messages to be transmitted. The additional second transmission message is transmitted separately from the additional first transmission message by the sending communication device 60 to the receiver's communication device 80.

Optionally, the additional second transmission message may further include an additional ID list, wherein the additional ID list contains the respective message ID corresponding to each of the additional messages to be transmitted. The another sender composite authentication code in the additional second transmission message may, for example, be generated by the sending communication device 60 according to the order recorded in the additional ID list.

In step S6, the receiver composite authentication code is generated from the multiple additional messages to be transmitted.

If the additional second transmission message includes the additional ID list, the communication device 80 needs to generate the receiver composite authentication code in the order specified in the additional ID list, to ensure correspondence with the additional sender composite authentication code. To this end, the receiver's communication device 80 may first extract the additional messages to be transmitted from the received additional first transmission message based on the additional ID list. These additional messages to be transmitted are associated with the received additional sender composite authentication code and thus serve as the basis for the security verification by the receiver. Then, the receiver's communication device 80 generates the receiver composite authentication code based on the selected additional message to be transmitted in the order recorded in the additional ID list.

For example, the receiver communication device 80 may perform a serialization operation (sorting and concatenation) on the collected plurality of additional messages to be transmitted according to a predefined order, thereby forming an additional composite message. With the additional composite message, the receiver composite authentication code may be generated using an encryption algorithm and a key. This process is similar to the generation of the sender composite authentication code, and specific details can be found in the earlier description in conjunction with FIG. 1.

Optionally, without a specific list of IDs to guide the ordering of the messages, the receiver's communication device 80 may generate the receiver composite authentication code according to a set of standard operating procedures. This may involve processing the message using a fixed algorithm or method.

In step S7, the receiver's communication device 80 performs a security verification on the plurality of additional messages to be transmitted based on the receiver composite authentication code and the additional sender composite authentication code. This may be achieved, for example, by comparing the two composite authentication codes. With this security verification mechanism, unauthorized tampering with the additional messages to be transmitted can be effectively prevented, as even minor modifications to the messages will result in a mismatch between the authentication codes. Optionally, if it is determined in step S7 that the security verification of the plurality of additional messages to be transmitted has failed, this security event may be reported to an upper layer.

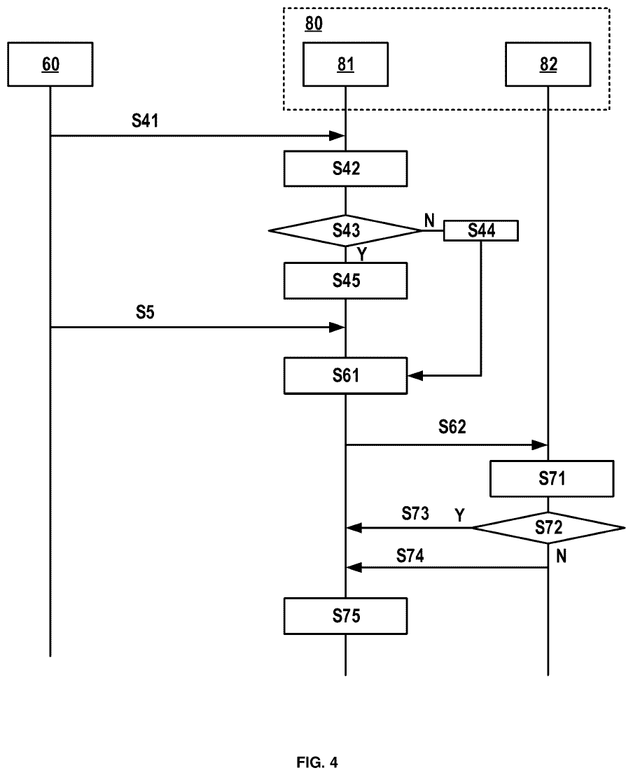

FIG. 4 illustrates a flowchart of a method for secure communication according to another exemplary embodiment of the present application. In this embodiment, the receiver's communication device 80 is further shown to include a main processor 81 and a hardware security module 82, thereby providing a more detailed depiction of the interaction between the two.

In step S41, the main processor 81 of the receiver communication device 80 receives an additional first transmission message. The specific operations and details of this step have already been described in FIG. 3 and will not be repeated here.

In step S42, the main processor 81 buffers the additional messages to be transmitted that are included in the additional first transmission message.

In step S43, the main processor 81 classifies the received additional messages to be transmitted to determine whether each message is a non-blocking message or a blocking message.

If the additional message to be transmitted pertains to a non-blocking message, the main processor 81 directly provides the additional message to the upper layer for use in step S44, and performs a security verification based on the received additional sender composite authentication code at a later point in time. Generally, non-blocking messages correspond to messages with a lower security level. Such messages typically have higher timeliness requirements (e.g., navigation update information, traffic information, etc.). The upper-layer application can use these messages immediately, while security verification is performed asynchronously in the background. If the verification fails, the system may take certain actions, such as alerting the driver or revoking the control command that has been applied.

If the additional message to be transmitted involves a blocking message, the main processor 81 temporarily prevents the upper layer from using this additional message in step S45, until it passes a safety verification process in a subsequent step. Such messages correspond to messages with higher safety levels (e.g., vehicle control data). If these messages are used without verification, they may pose safety risks. As a result, the main processor 81 blocks these data and only releases them to the upper-layer application after the safety verification is completed.

By adopting this classification mechanism based on the security level of messages, the data processing flow and response time are optimized while ensuring safety, thereby offering a more reliable and efficient communication solution.

In step S5, the main processor 81 of the communication device 80 receives another second transmission message. It can be seen that the another second transmission message is received later than the another first transmission message. However, due to the design of non-blocking messages, which allows them to be used before the completion of safety verification, the reception delay of the second transmission message has minimal impact on non-blocking messages.

In step S61, the main processor 81 of the communication device 80 extracts multiple additional messages to be transmitted from the buffer queue based on the additional ID list included in the second transmission message, and performs a serialization operation to form a composite message. By way of example, each additional message ID to be transmitted, the corresponding additional sensitive data unit, and the additional freshness value may be concatenated in sequence to ultimately form the additional composite message.

Next, in step S62, the main processor 81 of the communication device 80 transmits the additional composite message along with the received composite authentication code from the sender to the hardware security module 82.

In step S71, the hardware security module 82 calculates a receiver composite authentication code based on the additional composite message. Next, at step S72, the hardware security module 82 compares the additional sender composite authentication code with the receiver composite authentication code and determines whether they match. If they do not match, a result of failed security verification is returned to the main processor 81 in step S73. If the additional sender composite authentication code matches the receiver composite authentication code, a result of successful security verification is returned to the main processor 81 in step S74.

In step S75, the main processor 81 takes corresponding actions based on the result of the security verification. For example, if the security verification passes, the main processor 81 retrieves the blocked messages from the buffer queue and forwards them to other components or upper layers for use. In addition, the main processor 81 may report the result of the security verification to the upper layer. Exemplarily, if the security verification fails, the main processor 81 reports this security event to the upper layer. Optionally, for non-blocking messages that have already been used, the main processor 81 may also additionally report the successful security verification result to the upper layer, so that the upper layer application can take appropriate subsequent actions.

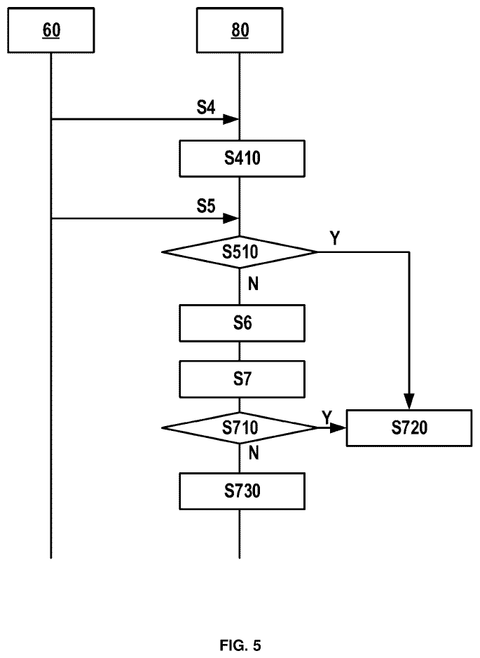

FIG. 5 illustrates a flowchart of a method for secure communication according to another exemplary embodiment of the present application.

Compared with the method shown in FIG. 3, the method illustrated in FIG. 5 further includes an additional step S410 after step S4. In an additional step S410, a receiver timer is activated in response to receiving an additional message to be transmitted. With the help of the receiver timer, continuous checking can be performed to determine whether the receiver timer has timed out.

In one embodiment, for example, at least one receiver timer corresponding to each received additional message to be transmitted can be started. The timing length of each receiver timer is determined by the urgency level of the corresponding additional message to be transmitted. The higher the urgency, the shorter the timing length. For each received additional message to be transmitted, the system independently monitors its corresponding receiver timer to check for timeout conditions. Optionally, if a message with the same ID arrives, the timer is not reset in order to avoid unnecessary repeated timing.

Specifically, the method shown in FIG. 5 further includes an additional step S510. In this step S510, it is checked whether a composite authentication code from another sender has been received before the receiver timer expires. If it has not been received, a timeout of the receiver timer is determined. This check is illustrated as being performed after the reception of the second additional transmission message (i.e., after step S5). The receiver timer may, for example, calculate the time difference between the reception of the second and the first additional transmission messages and determine whether the time difference exceeds a preset threshold. If the threshold is exceeded, a timeout is indicated. If a timeout is determined, a timeout event is reported to the upper layer in step S720, and the subsequent security authentication process is terminated. Meanwhile, the additional message to be transmitted is blocked from being provided to the upper layer. If no timeout is determined, the subsequent security authentication process may proceed, and the corresponding timer is reset (cleared). In embodiments not shown, the additional step S510 may also be executed before step S5 or in parallel with it.

In addition, the method shown in FIG. 5 further includes an additional step S710. In this additional step S710, it is checked whether the security verification of multiple other messages pending transmission has been completed before the expiration of the receiver timer; if not, a timeout of the receiver timer is determined. If a timeout is determined, an additional step S720 is performed to report the timeout event to the upper layer and to prevent the other messages pending transmission from being provided to the upper layer. If no timeout is determined, the related timer is reset (cleared) in step S730, so as to provide timing services in the next security verification cycle. This additional step is shown to be performed after step S7, but the check can likewise be performed before step S7 or S6, or in parallel with step S6 or S7.

In the method of secure communication shown in FIG. 5, two independent timeout checks are performed, for example, based on two different receiver timers. Although these two timers share the same starting point, they may have different timeout durations to accommodate the varying requirements of the secure communication process. The first timer involved in step S510 may have a shorter timeout duration. Its purpose is to check whether the composite authentication code from the additional sender is received within the prescribed period. This helps ensure the timeliness and authenticity of data. Compared to the first timer involved in step S510, the second timer involved in step S710 generally has a longer timeout duration. Its purpose is to check whether the security verification of multiple additional messages to be transmitted has been successfully completed within the specified time, which helps ensure the high efficiency of the system's processing. If either timer times out, a timeout event may be reported to the upper layer in the additional step S720, and the security verification process may be terminated accordingly, while preventing the additional messages to be transmitted from being made available to the upper layer. Depending on the requirements of the application scenario, the two timers may run in parallel to simultaneously monitor the receipt of the authentication code and the completion of the security verification process; alternatively, they may be executed sequentially, first monitoring the expiration of the timer for receiving the composite authentication code, and then setting the time limit for completing the security verification based on it. In practical applications, the required types and quantities of timers can be configured as needed.

In addition, if a different receiver timer is set separately for each additional message to be transmitted, the timeout status of the timer needs to be independently monitored for each additional message to be transmitted in the above steps S510 and S710. For example, if any of the additional messages to be transmitted is timed out by a receiver timer, the communication device 80 will report the timeout event and may interrupt the subsequent secure authentication process for all of the additional messages to be transmitted to ensure that data security is not compromised. The communication device 80 may also take the corresponding measures until the number of timer timeouts exceeds a predefined threshold. For instance, specific security policies or error recovery procedures are only executed when the number of timeout events exceeds a predefined threshold. By independently monitoring the timer of each additional message to be transmitted, the communication device 80 can allocate resources more efficiently and prevent the timeout of a single message from affecting the processing of other messages.

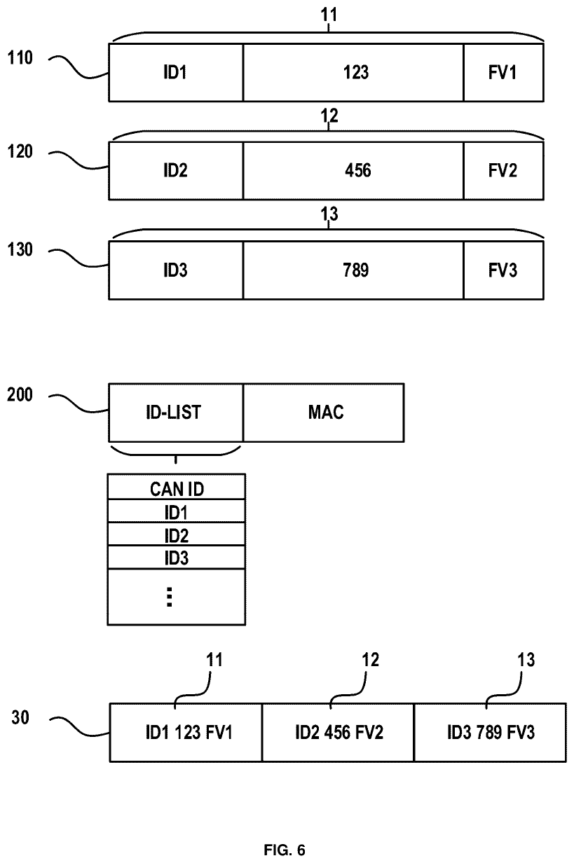

FIG. 6 illustrates a data structure diagram of the first transmission message, second transmission message, and composite message according to an exemplary embodiment of the present application.

As shown in FIG. 6, three first transmission messages 100, 110, and 120 are illustrated, each containing a message to be transmitted 11, 12, and 13, respectively. Each message to be transmitted 11, 12, and 13 consists of a message ID, a sensitive data unit, and a freshness value, respectively. Other field descriptions of the first transmission messages 110, 120, and 130 are omitted here. It is understood that the first transmission messages 100, 110, and 120 may also include other CAN protocol fields not detailed in FIG. 6, such as CRC fields and frame end flags. The message ID, for example, is used to uniquely identify the message to be transmitted and may also contain basic information such as the source and destination addresses. The freshness value ensures timeliness and order of the messages. The sensitive data unit includes key data that needs to be kept confidential or securely transmitted, and it is stored in the fixed-length payload field of the first transmission messages 100, 110, and 120.

The second transmission message 200 includes the sender composite authentication code MAC, which is calculated based on the plurality of messages 11, 12, and 13 to be transmitted for validating the integrity and source of the messages 11, 12, and 13 as a whole. The second transmission message 200 also carries an ID list that includes the message IDs for all messages to be transmitted that participates in the calculation of the composite authentication code.

FIG. 6 further illustrates a composite message 30 generated from multiple messages 11, 12, and 13 to be transmitted. Exemplarily, these messages 11, 12, and 13 to be transmitted are grouped together in a specific order to form a contiguous data sequence.

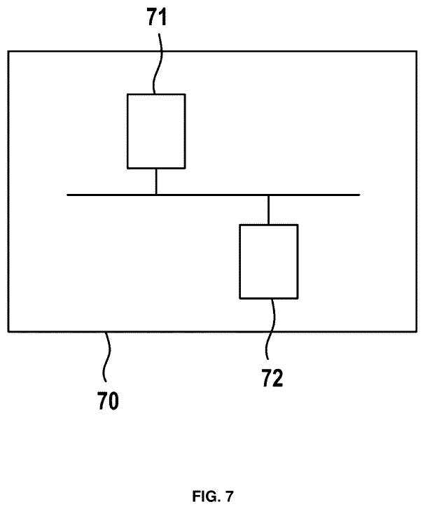

FIG. 7 illustrates a schematic diagram of a communication device 70 according to an exemplary embodiment of the present application.

Under the complete vehicle distributed communication architecture, the communication device 70 may be implemented, for example, as an electronic control unit. Further, the communication device 70 may also be implemented as a domain controller or a gateway. The communication device 70 may serve as both a sender and a receiver, and it may also integrate the functions of the sender and the receiver.

As shown in FIG. 7, the communication device 70 includes a processor 71 and a memory 72. The memory 72 stores computer program instructions, which, when executed by the processor 71, enable the processor to perform the security communication methods illustrated in FIG. 1 through FIG. 5. The computer program instructions can be stored in a computer-readable storage medium. The computer-readable storage medium may include, for example, high-speed random access memory, as well as non-volatile memory such as hard drives, internal memory, plug-in hard drives, smart storage cards, secure digital cards, flash memory cards, at least one magnetic storage device, flash memory devices, or other non-volatile solid-state storage devices. The processor 71 can be a central processing unit, or it may be another general-purpose processor, a digital signal processor, an application-specific integrated circuit, a commercially available programmable gate array or other programmable logic device, discrete gates or transistor logic devices, discrete hardware components, or the like.

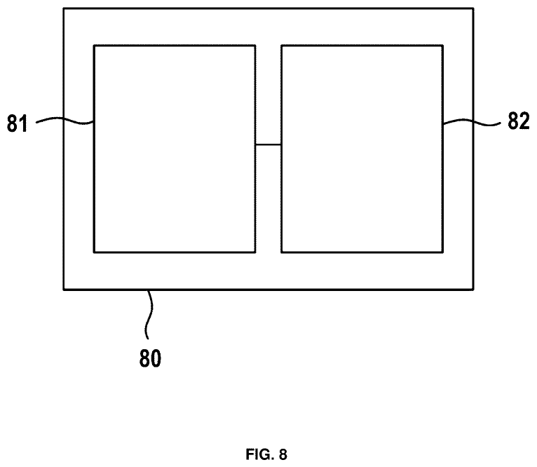

FIG. 8 illustrates a schematic diagram of a communication device according to another exemplary embodiment of the present application, which may be used, for example, as a sender.

As shown in FIG. 8, the communication device 80 includes, for example, a main processor 81 and a hardware security module 82. The main processor 81 and the hardware security module 82 are connected to each other for data exchange via one or more lines, which may be serial or parallel connections, and may be point-to-point or implemented via a bus. In the present embodiment, the main processor 81 and the hardware security module 82 may each include a different processor core. The main processor 81 and the hardware security module 82 may be arranged on the same printed circuit board (PCB) that is physically packaged, for example, forming a domain controller.

The main processor 81 is primarily responsible for data exchange with upper-layer applications and the bus, as well as preparing the messages to be transmitted. The hardware security module 82 is responsible for securely storing and managing keys, while also providing data encryption, decryption, signing, and verification functions. In this embodiment, the hardware security module 82 is used primarily to perform generation and verification of the composite authentication code.

Specifically, the main processor 81 receives sensitive data units from the upper layer. These sensitive data units may contain various types of information, such as sensor data, traffic information, or vehicle control information. The main processor 81 then processes these sensitive data units to prepare the messages to be subjected to security verification. For example, the main processor 81 may assign a freshness value and message ID to each sensitive data unit, thereby constructing the messages to be transmitted. Next, multiple messages to be transmitted are serialized (i.e., concatenated in a certain order) to form a composite message, which is then transmitted to the hardware security module 82. In addition, the main processor 81 also sends multiple messages as a first transmission message to the receiver, wherein these first transmission messages themselves do not contain any message authentication code. Finally, the main processor 81 receives the composite authentication code from the hardware security module 82 and sends it, independently of the messages themselves, as a second transmission message to the receiver.

The hardware security module 82 is configured to perform the following operations: It generates a sender composite authentication code based on the composite message received from the main processor 81 and transmits the sender composite authentication code back to the main processor 81.

In another embodiment, the main processor 81 may also be configured to perform the following operations: It is responsible for receiving an additional first transmission message and an additional second transmission message that are transmitted separately. The additional first transmission message carries the additional messages to be transmitted themselves but does not include the authentication codes of these messages. The second transmission message includes an overall additional sender composite authentication code generated for the plurality of additional messages to be transmitted. The main processor 81 is further configured to generate an additional composite message based on the received additional messages to be transmitted, and transmit the additional composite message along with the received additional sender composite authentication code to the hardware security module 82.

In another embodiment, the hardware security module 82 may further be configured to perform the following operations: It is responsible for generating a receiver composite authentication code based on the additional composite message received from the main processor 81. Using the generated receiver composite authentication code and the received additional sender composite authentication code, it performs security verification on the plurality of additional messages to be transmitted.

For specific details, refer to the description above in conjunction with FIGS. 1 to 5, which will not be repeated here.

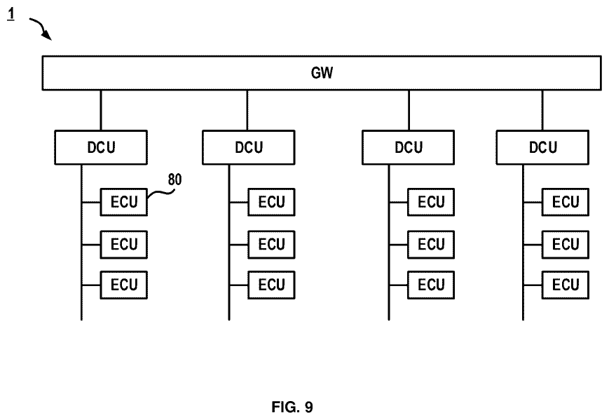

FIG. 9 illustrates a schematic diagram of a communication system 1 according to an exemplary embodiment of the present application.

The communication system 1 is exemplarily illustrated as a communication system within a modern vehicle's electronic and electrical (E/E) architecture and includes the communication device 80 as shown in FIG. 8. In more complex implementations, the communication system 1 may also include a Gateway (GW), a Domain Controller (DCU), an Electronic Control Unit (ECU), and a CAN bus. For example, the communication system 1 can be functionally divided into multiple domains (such as the powertrain domain, chassis domain, body domain, cockpit domain, and autonomous driving domain), each domain including at least one domain controller responsible for managing multiple ECUs connected to the CAN bus and for isolating the CAN domain. All these domain controllers communicate across domains through gateways. The communication system may also include other devices such as repeaters.

In FIG. 9, although the communication device 80 is exemplarily implemented as an ECU, the present application is not limited thereto. In fact, the communication device 80 may also be implemented as a domain controller or a gateway. The present application does not specifically limit the number and type of communication devices included in the communication system 1.

It should be understood that the method according to the various examples of the present disclosure can be achieved by computer programs/software. These software programs can be loaded into the working memory of the processor and, when executed, perform the methods according to the various examples of the present disclosure.

According to another embodiment of the present disclosure, a computer program product comprising a computer program is provided, wherein the computer program is configured to, when executed on a computer or stored on a computer-readable storage medium (e.g., CD-ROM), perform the methods according to various embodiments of the present disclosure. The machine-readable storage medium may be, for example, an optical storage medium or a solid-state medium supplied together with other hardware or as a part of other hardware.

Although specific embodiments of the present application have been described in detail here, they are provided solely for explanatory purposes and should not be construed as limiting the scope of the present application. Various substitutions, alterations, and modifications may be conceived without departing from the spirit and scope of the present application.

What is claimed is:

1. A method for secure communication, comprising:
(S1) generating a sender composite authentication code based on multiple messages to be transmitted, wherein the sender composite authentication code is used for the security verification of the entirety formed by the multiple messages to be transmitted;
(S2) transmitting the multiple messages to be transmitted to the receiver as first transmission messages, wherein the first transmission messages do not contain any form of authentication code; and
(S3) transmitting the sender composite authentication code to the receiver as a second transmission message, wherein the second transmission message is sent separately from the first transmission messages.

2. The method according to claim 1, wherein:
the step (S1) comprises generating an ID list based on multiple messages to be transmitted, wherein the ID list comprises the message IDs of each message to be transmitted, and generating the sender composite authentication code based on the multiple messages to be transmitted arranged in the order of the message IDs recorded in the ID list; and
the step (S3) comprises combining the sender composite authentication code and the ID list together into a second transmission message, and sending the second transmission message to the receiver.

3. The method according to claim 1, further comprising:
generating, by a main processor of a communication device, a composite message based on multiple messages to be transmitted by sequentially concatenating the message ID, sensitive data unit, and freshness value of each message to be transmitted to form the composite message;
transmitting the composite message from the main processor of the communication device to a hardware security module of the communication device, wherein the main processor and the hardware security module have different processor cores; and
calculating, by the hardware security module of the communication device, a sender composite authentication code based on the composite message.

4. The method according to claim 1, wherein:
in the step (S2), multiple first transmission messages are transmitted independently, each of the first transmission messages, including one message to be transmitted of the multiple messages to be transmitted, or a single first transmission message is transmitted, the single first transmission message including a composite message generated from the multiple messages to be transmitted; and
in the step (S3), a second transmission message is transmitted at a time that is lagging the first transmission message.

5. The method according to claim 1, wherein:
the step (S1) comprises copying each message to be transmitted into a buffer, and stopping the copying process when the number of buffered messages to be transmitted reaches a preset threshold, then generating a sender composite authentication code using all the buffered messages to be transmitted, and
the step (S2) comprises immediately transmitting the copied message to be transmitted as a first transmission message after it has been copied into the buffer.

6. The method according to claim 1, wherein in the step (S1), the timing for generating the sender composite authentication code is determined by a sender timer, and wherein:
messages to be transmitted are continuously copied into the buffer before the sender timer expires, and
when the sender timer expires, the collection of messages to be transmitted is stopped, and the sender composite authentication code is generated using all the buffered messages to be transmitted.

7. The method according to claim 6, wherein:
the sender timer is a periodic timer, the periodic timer having a timing start point and a preset timing period independent of external events; or
the sender timer is started in response to collecting the messages to be transmitted used for generating the sender composite authentication code, and has a timing length associated with the messages to be transmitted.

8. The method according to claim 6, wherein, in response to collecting each message to be transmitted, a corresponding sender timer is started; the timing length of each sender timer is determined by the urgency level of the respective message to be transmitted; and the sender composite authentication code is generated upon the expiration of the earliest sender timer among all sender timers.

9. The method according to claim 1, further comprising:
(S4) receiving an additional first transmission message, which includes multiple additional messages to be transmitted and does not contain any form of authentication code;
(S5) receiving an additional second transmission message, which includes an additional sender composite authentication code, the additional sender composite authentication code being used for the security verification of the group of additional messages to be transmitted as a whole, wherein the additional second transmission message is transmitted separately from the additional first transmission message;
(S6) generating a receiver composite authentication code from the multiple additional messages to be transmitted; and
(S7) performing security verification on the multiple additional messages to be transmitted based on the receiver composite authentication code and the additional sender composite authentication code.

10. The method according to claim 9, wherein the additional second transmission message further comprises an additional ID list, the additional ID list including an additional message ID for each of the additional messages to be transmitted, and wherein the step (S6) comprises:
based on the additional ID list, selecting from the received additional first transmission messages the following additional messages to be transmitted, wherein these additional messages to be transmitted are associated with the received additional sender composite authentication code; and
in accordance with the order of the additional message IDs recorded in the additional ID list, generating the receiver composite authentication code based on the selected additional messages to be transmitted.

11. The method according to claim 9, further comprising:
generating, by the main processor of the communication device, an additional composite message based on the multiple additional messages to be transmitted by sequentially concatenating the additional message ID, the additional sensitive data unit, and the additional freshness value of each of the additional messages to be transmitted, and transmitting the additional composite message along with the received additional sender composite authentication code by the main processor of the communication device to the hardware security module, wherein the main processor and the hardware security module have different processor cores; and
calculating a receiver composite authentication code based on the additional composite message by the hardware security module of the communication device, and comparing the additional sender composite authentication code with the receiver composite authentication code, and if the additional sender composite authentication code and the receiver composite authentication code do not match, the security verification fails, and if they match, the security verification is deemed successful.

12. The method according to claim 8, further comprising:
after receiving the additional first transmission message, the additional message to be transmitted included therein is buffered; and
upon receipt of the additional second transmission message, security verification is performed on the buffered additional messages to be transmitted based on the additional sender composite authentication code contained in the additional second transmission message.

13. The method according to claim 8, further comprising categorizing the received additional messages to be transmitted into non-blocking messages and blocking messages, wherein:
if the additional message to be transmitted pertains to a non-blocking message, it is directly provided to the upper layer for use, and security verification based on the received additional sender composite authentication code is performed at a later time; and
if the additional message to be transmitted pertains to a blocking message, its use by the upper layer is temporarily withheld until security verification is successfully completed, after which it is provided to the upper layer.

14. The method according to claim 8, further comprising:
in response to receiving the additional message to be transmitted, a receiver timer is started, and the timer is continuously monitored for timeout, and if a timeout is detected, a timeout event is reported to the upper layer; and/or
if it is determined in the step (S7) that the security verification of the multiple additional messages to be transmitted has failed, a security event is reported to the upper layer.

15. The method according to claim 14, wherein a determination of whether the receiver timer has timed out is performed by the following:
checking whether the additional sender composite authentication code has been received before the receiver timer expires, and if not received, determining that the receiver timer has timed out; and/or
checking whether the security verification of multiple additional messages to be transmitted has been completed before the receiver timer expires, and if not completed, determining that the receiver timer has timed out.

16. The method according to claim 14, wherein in response to receiving each message to be transmitted, at least one corresponding receiver timer is started, the timing duration of the receiver timer being determined by the urgency level of the additional message to be transmitted, and the receiver timers corresponding to each received additional message to be transmitted are independently monitored for timeout.

17. A communication device, comprising a memory and a processor, wherein the memory stores computer program instructions, and when the computer program instructions are executed by the processor, the processor is configured to perform the method according to claim 1.

18. A communication device, comprising:
a main processor configured to:
generate a composite message based on multiple messages to be transmitted;
transmit the composite message to a hardware security module;
receive a sender composite authentication code from the hardware security module;
transmit multiple messages to be transmitted to a receiver as first transmission messages, wherein the first transmission messages do not include any form of authentication code; and
transmit the sender composite authentication code to the receiver as a second transmission message, wherein the second transmission message is sent separately from the first transmission messages; and
a hardware security module configured to:
generate the sender composite authentication code based on the composite message; and
transmit the sender composite authentication code to the main processor.

19. The communication device according to claim 18, wherein:
the main processor is further configured to:
receive an additional first transmission message which includes multiple additional messages to be transmitted and does not contain any form of authentication code;
receive an additional second transmission message which includes an additional sender composite authentication code, the additional sender composite authentication code being used for the security verification of the group of additional messages to be transmitted as a whole, wherein the additional second transmission message is transmitted separately from the additional first transmission message;
generate an additional composite message based on the received multiple additional messages to be transmitted; and
transmit an additional composite message and the received additional sender composite authentication code to a hardware security module; and
the hardware security module is further configured to:
generate a receiver composite authentication code based on the additional composite message; and
perform security verification on the multiple additional messages to be transmitted based on the receiver composite authentication code and the additional sender composite authentication code.

20. The communication device according to claim 18, wherein the communication device is implemented as a domain controller, electronic control unit, or gateway.

21. A computer program product comprising a computer program, wherein the computer program, when executed by a processor, implements the method according to claim 1.
